(19) United States
(12) Patent Application Publication
(10) Pub. No.: US 2009/0135359 A1
(43) Pub. Date: May 28, 2009

(54) LIQUID CRYSTAL DEVICE AND ELECTRONIC APPARATUS

(75) Inventors: Ayae SAWADO, Kai-shi (JP); Shinsuke FUJIKAWA, Chino-shi (JP)

Correspondence Address: LOWE HAUPTMAN HAM & BERNER, LLP, 1700 DIAGONAL ROAD, SUITE 300, ALEXANDRIA, VA, 22314, US

(73) Assignee: SEIKO EPSON CORPORATION, Tokyo (JP)

(21) Appl. No.: 12/267,720

(22) Filed: Nov. 10, 2008

(30) Foreign Application Priority Data
Nov. 27, 2007 (JP) 2007-305358

(51) Int. Cl. G02F 1/1343

(52) U.S. Cl. 349/139

(57) ABSTRACT

There is provided a liquid crystal device that has a liquid crystal layer pinched by a first substrate and a second substrate disposed to face each other and performs a display operation by transiting the aligning state of the liquid crystal layer from spray alignment to bend alignment. The first substrate includes a scanning line and a data line that intersect with each other, a plurality of pixel electrodes, an insulating film that is disposed to the liquid crystal layer side relative to the scanning line and the data line, a transition electrode that is electrically connected to the scanning line or the data line through a contact hole formed on the insulating film, and a dielectric film that is disposed between the transition electrode and the pixel electrode. In addition, the transition electrode generates an electric potential difference between the pixel electrode and the transition electrode with the dielectric film interposed therebetween.

### BACKGROUND

1. Technical Field

The present invention relates to a liquid crystal device and an electronic apparatus.

2. Related Art

In the field of liquid crystal displays that are represented by liquid crystal television sets and the like, in order to improve the image quality of moving pictures, recently, liquid crystal display devices of an OCB (Optical Compensated Bend) mode having a high response speed have been in the limelight. In the OCB mode, in the initial state, a liquid crystal is in a spray alignment state in which the liquid crystal is open in a spray shape between two substrates. Thus, in a display operation, the liquid crystal is needed to be in a state (bend alignment) that the liquid crystal is bent in a bow shape. In other words, high-speed responsiveness is implemented by modulating the transmissivity to the degree of curving of the bend alignment in the display operation.

As described above, in the liquid crystal device of the OCB mode, the liquid crystal for a case where power is turned off is in the spray alignment state. Thus, so-called an initial transition operation for transiting the aligning state of the liquid crystal from the initial spray alignment to the bend alignment for the display operation by applying a voltage of a minimum threshold value, which is required for generating a reaction that occurs in the power-off state, or more is required. In JP-A-2001-296519, technology for promoting initial alignment transition of the liquid crystal by using a horizontal electric field generated between pixel electrodes has been disclosed. In addition, In JP-A-2003-84299, technology for forming the bend alignment in the vicinity of a display area by using a transition preventing electrode located in the vicinity of the display area has been disclosed.

However, in JP-A-2001-296519, a bend part is located in a pixel electrode, and accordingly, the area of a light shielding layer (a black matrix layer) increases. As a result, there is a problem that the aperture ratio of a panel decreases. In addition, in JP-A-2003-84299, there is a problem that formation of a new TFT (Thin Film Transistor) element and the like are required for control driving of the transition electrode and the configuration of a driver becomes complicated so as to drive the TFT element and the like. Furthermore, since an end part of the pixel electrode is disposed on the transition electrode, parasitic capacitance exists between the transition electrode and the pixel electrode. In addition, in the holding period of a data signal, the electric potential of the pixel electrode is influenced by an electric potential change of the transition electrode through the parasitic capacitance. In addition, since the amplitude of the electric potential of the pixel electrode becomes asymmetrical, a DC voltage is supplied to a liquid crystal layer. Thus, there is a problem that flicker and burn-sticking are generated.

### SUMMARY

An advantage of some aspects of the invention is that it provides a liquid crystal device and an electronic apparatus. The invention may be implemented as the following forms or application examples.

### APPLICATION EXAMPLE 1

According to Application Example 1 of the invention, there is provided a liquid crystal device that has a liquid crystal layer pinched by a first substrate and a second substrate disposed to face each other and performs a display operation by transiting the aligning state of the liquid crystal layer from spray alignment to bend alignment. The first substrate includes: a scanning line and a data line that intersect with each other; a plurality of pixel electrodes; an insulating film that is disposed to the liquid crystal layer side relative to the scanning line and the data line; a transition electrode that is electrically connected to the scanning line or the data line through a contact hole formed on the insulating film; and a dielectric film that is disposed between the transition electrode and the pixel electrode. In addition, the transition electrode generates an electric potential difference between the pixel electrode and the transition electrode with the dielectric film interposed therebetween.

According to this application example, a transition nucleus that becomes the point of origin for the initial transition can be formed by generating an electric field between the pixel electrode and the transition electrode. In addition, transition of the alignment can be implemented by a simple control operation by connecting the transition electrode and the gate line through the contact hole.

### APPLICATION EXAMPLE 2

According to Application Example 2 of the invention, there is provided the above-described liquid crystal device, wherein at least a part of the transition electrode is overlapped with an end part of the pixel electrode in a plan view.

According to this application example, a structure in which the transition electrode and the pixel electrode are vertically disposed is formed. Thus, by decreasing the film thickness of the insulating layer (a dielectric film) that is interposed between the electrodes, a distance between the electrodes can be shortened, compared to a general electrode structure using the horizontal electric field. As a result, the initial transition can be performed in a short time by using a low voltage.

### APPLICATION EXAMPLE 3

According to Application Example 3 of the invention, there is provided the above-described liquid crystal device, wherein a bend part is formed in the pixel electrode or the transition electrode.

According to this application example, electric fields are generated in multiple directions between the pixel electrode and the transition electrode, and accordingly, the transition nucleus can be generated more assuredly by the bend parts. Therefore, the uniformity and speed of the initial transition can be improved further.

### APPLICATION EXAMPLE 4

According to Application Example 4 of the invention, there is provided the above-described liquid crystal device, wherein the transition electrode is electrically connected to the scanning line through the contact hole and is disposed in a same layer as that of the data line.

According to this application example, the transition electrode can be disposed in a desired position within the pixel area. Accordingly, the place in which the transition nucleus forming the point of origin of the initial alignment transition is generated can be set to an arbitrary position. In addition, by simultaneously forming the source line and the transition electrode, the substrate can be produced by using a simple process.

### APPLICATION EXAMPLE 5

According to Application Example 5 of the invention, there is provided the above-described liquid crystal device, wherein the transition electrode is overlapped with an end part of the pixel electrode that is driven by the scanning line that is disposed to be adjacent to the scanning line to which the transition electrode is electrically connected.

According to this application example, a gap between the transition electrode and an adjacent pixel electrode in a plan view is not generated, and accordingly, a holding capacitor can be configured between the transition electrode and the adjacent pixel electrode. In addition, the film thickness of the dielectric body between the holding capacitor electrode and the pixel electrode can decrease. Accordingly, the capacitance of the storage capacitor can increase without increasing the area of the holding capacitor electrode. Therefore, flicker and burn-sticking can be reduced without decreasing the aperture ratio.

### APPLICATION EXAMPLE 6

According to Application Example 6 of the invention, there is provided the above-described liquid crystal device, wherein the transition electrode is electrically connected to the data line through the contact hole.

According to this application example, the transition nucleus that becomes the point of origin of the initial transition can be formed in a broad range by generating a broad electric field between the pixel electrode and the transition electrode.

### APPLICATION EXAMPLE 7

According to Application Example 7 of the invention, there is provided an electronic apparatus having the above-described liquid crystal device.

According to this application example, the liquid crystal device of the OCB mode that can perform the initial alignment transform in a short time by using a low voltage is included, and accordingly, the electronic apparatus having superior display quality can be provided.

### BRIEF DESCRIPTION OF THE DRAWINGS

The invention will be described with reference to the accompanying drawings, wherein like numbers reference like elements.

FIGS. 1A and 1B are diagrams showing a schematic configuration of a liquid crystal device according to a first embodiment of the invention.

FIG. 2 is a diagram showing an equivalent circuit of the liquid crystal device according to the first embodiment.

FIG. 3 is a plan view of a sub pixel area according to the first embodiment.

FIG. 4 is a diagram showing a sectional structure of the liquid crystal device according to the first embodiment.

FIG. 5 is a diagram showing a sectional structure of the liquid crystal device according to the first embodiment.

FIGS. 6A and 6B are schematic diagrams showing the aligning states of liquid crystal molecules according to the first embodiment.

FIG. 7 is a diagram showing a schematic configuration of a liquid crystal device according to a second embodiment of the invention.

FIG. 8 is a plan view of a sub pixel area according to a third embodiment of the invention.

FIG. 9 is a diagram showing a sectional structure of a liquid crystal device according to the third embodiment.

FIG. 10 is a timing chart for the initial transition operation of the liquid crystal device according to the third embodiment.

FIG. 11 is a perspective view showing an example of an electronic apparatus according to an embodiment of the invention.

### DESCRIPTION OF EXEMPLARY EMBODIMENTS

Hereinafter, a liquid crystal device and an electronic apparatus according to embodiments of the present invention will be described with reference to the accompanying drawings. In each drawing used for descriptions below, in order to represent constituent elements in sizes recognizable, scales thereof are appropriately changed. In descriptions below, a minimum unit of image display is referred to as a sub pixel, and a set of a plurality of sub pixels having color filters of each color is referred to as a pixel.

### First Embodiment

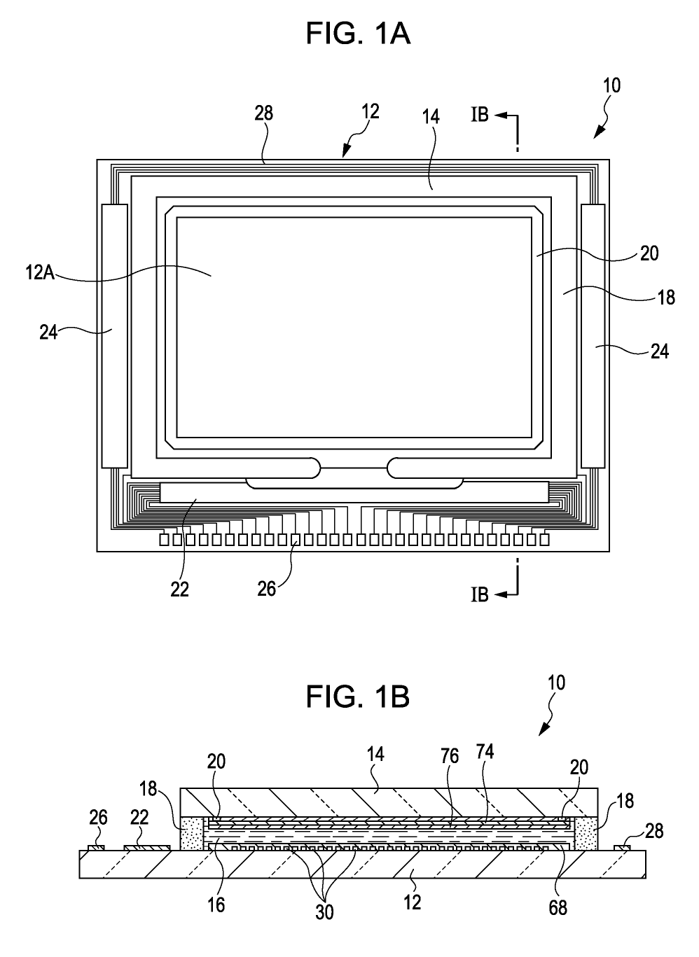

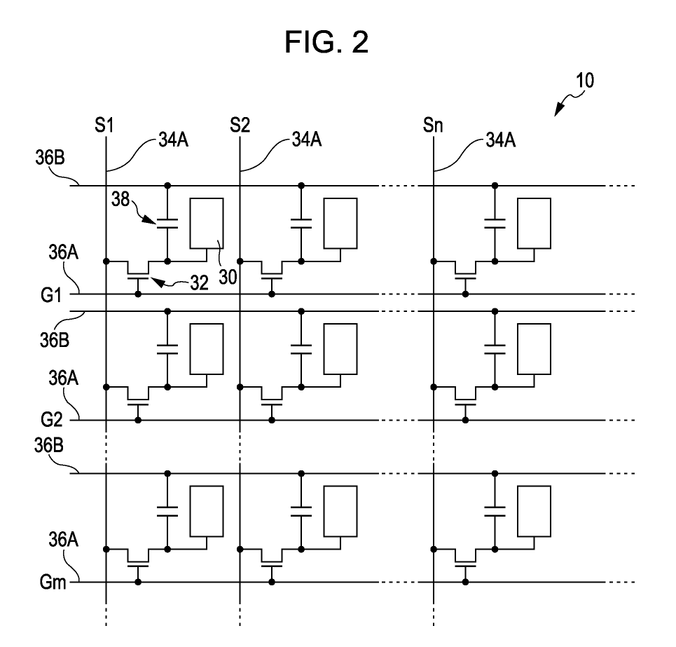

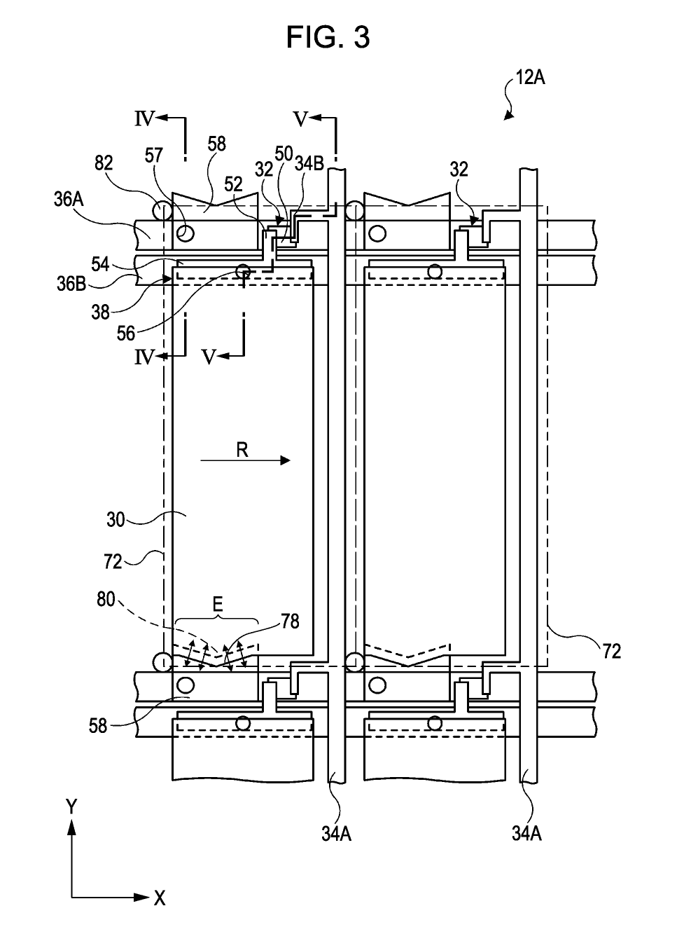

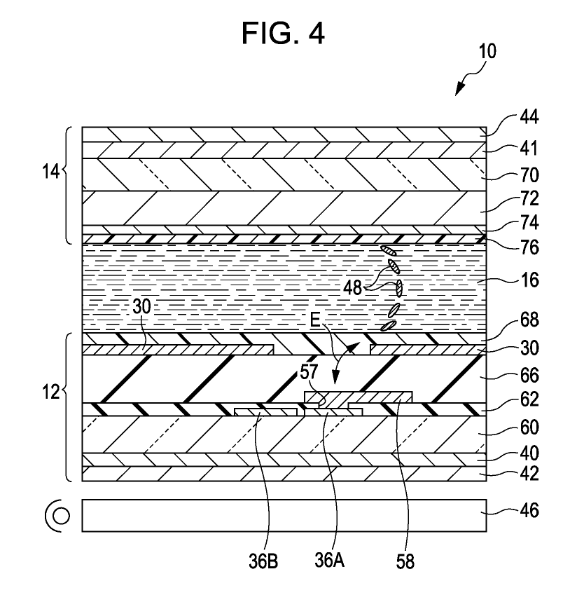

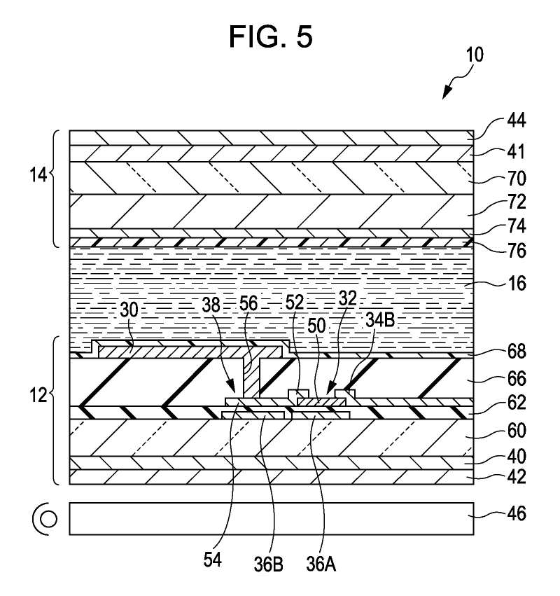

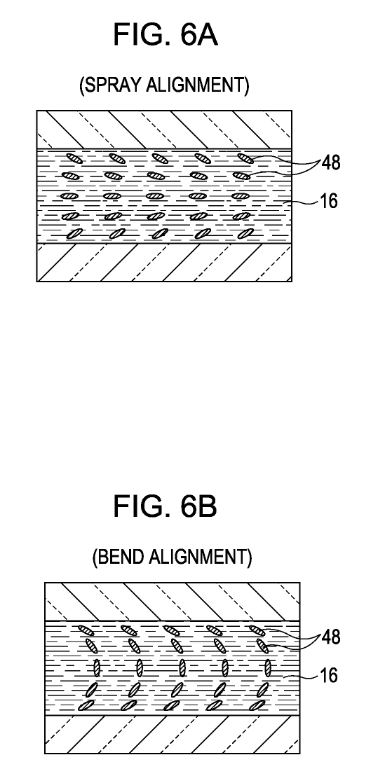

FIGS. 1A and 1B are diagrams showing a schematic configuration of a liquid crystal device according to a first embodiment of the invention. FIG. 1A is a plan view of the liquid crystal device. FIG. 1B is a cross-sectional view taken along line IB-IB shown in FIG. 1A. FIG. 2 is a diagram showing an equivalent circuit of the liquid crystal device according to this embodiment. FIG. 3 is a plan view of a sub pixel area according to this embodiment. FIGS. 4 and 5 are diagrams showing a sectional structure of the liquid crystal device according to this embodiment. FIG. 4 is a cross-sectional view taken along line IV-IV shown in FIG. 3. In addition, FIG. 5 is a cross-sectional view taken along line V-V shown in FIG. 3. FIGS. 6A and 6B are schematic diagrams showing alignment states of liquid crystal molecules according to this embodiment.

The liquid crystal device according to this embodiment is an active-matrix liquid crystal device of a TFT type that uses a TFT element as a pixel switching element.

The liquid crystal device 10, as shown in FIG. 1, includes a component substrate (first substrate) 12, an opposing substrate (second substrate) 14 that is disposed to face the component substrate 12, and a liquid crystal layer 16 that is pinched by the component substrate 12 and the opposing substrate 14. Here, the liquid crystal layer 16 uses a liquid crystal material having positive dielectric anisotropy.

In addition, in the liquid crystal device 10, the component substrate 12 and the opposing substrate 14 are bonded together by a sealing member 18 so as to seal the liquid crystal layer 16 within an area partitioned by the sealing member 18. Along the inner periphery of the sealing member 18, a peripheral lead 20 is formed, and an area that is surrounded by the peripheral lead 20 and has a rectangular shape in a plan view (a state that the component substrate 12 is viewed from the opposing substrate 14 side) is formed as an image display area 12A.

In addition, the liquid crystal device 10 includes a data line driving circuit 22 and a scanning line driving circuit 24 that are disposed on the outer side of the sealing member 18, a connection terminal 26 that is in a conductive state with the data line driving circuit 22 and the scanning line driving circuit 24, and a wiring 28 that is connected to the scanning line driving circuit 24.

In the image display area 12A of the liquid crystal device 10, as shown in FIG. 2, a plurality of sub pixel areas is arranged to have a matrix shape in a plan view. In addition, TFT elements 32 that control switching of a pixel electrode 30 and a pixel electrode 30 are disposed in correspondence with the sub pixel areas. In the image display area 12A, a plurality of data lines 34A and a plurality of scanning lines 36A are formed to extend in a lattice shape. In other words, the sub pixel area corresponds to an area surrounded by the data lines 34A and the scanning lines 36A.

To the source of each TFT element 32, the data line 34A is electrically connected. In addition, to the gate of each TFT element 32, the scanning line 36A is electrically connected. The drain of each TFT element 32 is electrically connected to the pixel electrode 30. The data lines 34A are connected to the data line driving circuit 22 (see FIG. 1) and supply image signals S1, S2, . . . , Sn supplied from the data line driving circuit 22 to the sub pixel areas. The scanning lines 36A are connected to the scanning line driving circuit 24 (see FIG. 1) and supply scanning signals G1, G2, . . . , Gm supplied from the scanning line driving circuit 24 to the sub pixel areas. The image signals S1 to Sn supplied to the data lines 34A from the data line driving circuit 22 may be supplied in a line sequential manner in the mentioned order, or the image signals may be supplied to each group of the data lines 34A that are adjacent to each other. The scanning line driving circuit 24 supplies the scanning signals G1 to Gm to the scanning lines 36A as pulses at predetermined timings in a line sequential manner.

In the liquid crystal device 10, the TFT 32 as a switching element is in the On state only for a predetermined time period in accordance with input of the scanning signals G1 to Gm, and accordingly, the image signals S1 to Sn supplied from the data lines 34A are configured to be written into the pixel electrodes 30. Then, the image signals S1 to Sn of predetermined levels that are written into the liquid crystal through the pixel electrodes 30 are maintained between the pixel electrodes and a common electrode, to be described later, that are disposed to face the pixel electrodes 30 though the liquid crystal layer 16 for a predetermined time period.

Here, in order to prevent a leak of the maintained image signals S1 to Sn, storage capacitors 38 are connected in parallel with liquid crystal capacitors that are formed between the pixel electrodes 30 and the common electrode. Each storage capacitor 38 is disposed between the drain of the TFT element 32 and a capacitor line 36B.

Next, a detailed configuration of the liquid crystal device 10 will be described with reference to FIGS. 3 to 5. In FIG. 3, the direction of a longer side of the sub pixel area in the shape of an approximately rectangle in a plan view, the direction of a longer side of the pixel electrode 30, and the direction of extension of the data lines 34A are defined as the direction of axis Y. In addition, the direction of a shorter side of the sub pixel area, the direction of a shorter side of the pixel electrode 30, and the direction of extension of the scanning lines 36A and the capacitor lines 36B are defined as the direction of axis X.

The liquid crystal device 10, as shown in FIG. 4, is configured to have the component substrate 12 and the opposing substrate 14 that face each other with the liquid crystal layer 16 pinched therebetween, a phase difference plate 40 and a polarizing plate 42 that are disposed on the outer side (a side opposite the liquid crystal layer 16) in the component substrate 12, a phase difference plate 41 and a polarizing plate 44 that are disposed on the outer side (a side opposite to the liquid crystal layer 16) of the opposing substrate 14, and an illumination unit 46 that is disposed on the outer side of the polarizing plate 42 and emits illuminated light from the outer face side of the component substrate 12. The liquid crystal layer 16 is configured to operate in an OCB mode. When the liquid crystal device 10 is operated, as shown in FIG. 6B, liquid crystal molecules 48 represent bend alignment in which the liquid crystal molecules are aligned in the shape of an approximate bow.

As shown in FIG. 3, in each sub pixel area, the pixel electrode 30 in the shape of a rectangle in a plan view is formed. In the side end parts of the pixel electrode 30, the data lines 34A extend along the direction of axis Y, and the scanning lines 36A extend along the direction of axis X of the pixel electrode 30. On the pixel electrode 30 side of the scanning line 36A, a capacitor line 36B that extends in parallel with the scanning line 36A is formed.

On the scanning line 36A, the TFT element 32 as a switching element is formed. The TFT element 32 has a semiconductor layer 50 that is formed of an amorphous silicon film having an island shape and a source electrode 34B and a drain electrode 52 that are disposed to be partly overlapped with the semiconductor layer 50. The scanning line 36A serves as a gate electrode of the TFT element 32 in a position overlapped with the semiconductor layer 50. The scanning line 36A (the gate electrode), the source electrode 34B, the drain electrode 52, the data line 34A, and the capacitor line 36B may be formed of a metal substance, an alloy, metallic silicide, or poly silicide that include at least one metal such as titanium (Ti), chrome (Cr), tungsten (W), tantalum (Ta), and molybdenum (Mo) having a high melting-point, a lamination thereof, conductive poly silicon, or the like.

The source electrode 34B is connected to the data line 34A in an end part of a side opposite to the semiconductor layer 50. The drain electrode 52 is connected to a capacitor electrode 54 having an approximately rectangular shape in a plan view in an end part on a side opposite to the semiconductor layer 50. The capacitor electrode 54 is disposed in a planar area of the capacitor lines 36B, a storage capacitor 38 that has the capacitor electrode 54 and the capacitor line 36B as electrodes is configured. By electrically connecting the pixel electrode 30 and the capacitor electrode 54 together through a pixel contact hole 56 that is formed within a planar area of the capacitor electrode 54, the drain of the TFT element 32 and the pixel electrode 30 are in a conductive state. A transition electrode 58 is disposed in a lower layer of the pixel electrode 30 through a dielectric body. The transition electrode 58 is formed in a same layer as that of the data line 34A. Accordingly, by simultaneously forming the source line and the transition electrode as films, a substrate can be produced by using a simple process.

In the pixel electrode 30 and the transition electrode 58, bend parts 78 and 80 are formed. A side end of a shorter side of each pixel electrode 30 on the TFT element 32 side is in the shape curved partly. In other words, a convex part (the bend part) 78 in the shape of a triangle in a plan view that protrudes outward from the side end of the shorter side of the pixel electrode 30 toward the longitudinal direction of the pixel electrode 30 is formed.

The transition electrode 58 is overlapped with the end part of the pixel electrode 30 that is driven by a scanning line 36A that is disposed adjacent to a scanning line 36A electrically connected to the transition electrode 58. The transition electrode 58 is formed to extend from the connection part of the scanning line 36A and the contact hole 57 to the side end of a near shorter side to which the TFT element 32 of the pixel electrode 30 is connected. In addition, end parts of the transition electrode 58 and the pixel electrode are formed to be overlapped two-dimensionally with each other. In addition, as shown in FIG. 3, the shape of the transition electrode 58 is formed in accordance with that of the pixel electrode 30. Thus, a portion of the transition electrode 58 overlapped with the convex part 78 of the pixel electrode 30 is formed as a concave part (the bend part) 80 in the shape of a triangle concaved inward. The transition electrode 58 may be connected to the scanning line 36A that is disposed on a same stage as that of the pixel electrode 30.

In the initial transition operation, an electric potential difference (an electric field E) is generated between the convex part 78 of the pixel electrode 30 and the concave part 80 of the transition electrode 58. This electric field E is generated in both sides of the triangle and includes electric fields in two different directions. According to the above-described liquid crystal device, since electric fields in multiple directions are generated in the initial alignment transition, in areas (places corresponding to vertexes of the triangle) in which the electric fields E are intersected with each other, the alignment of the liquid crystal molecules 48 are particularly disturbed. Accordingly, the transition nucleus that becomes the point of origin can be generated well.

Thus, in the above-described liquid crystal device according to this embodiment, by generating an electric field E between the pixel electrode 30 and the transition electrode 58, the transition nucleus that becomes the point of origin of the initial transition can be formed. In such a case, electric fields E are generated in multiple directions between the pixel electrode 30 and the transition electrode 58 by the bend parts 78 and 80, and accordingly, the transition nucleus can be generated more assuredly by the bend parts 78 and 80. Therefore, the uniformity and speed of the initial transition can be improved further.

The transition electrode 58, as shown in FIGS. 4 and 5, is disposed in a layer that is positioned higher than that of the scanning line 36A or the data line 34A and lower than that of the pixel electrode 30. In addition, the transition electrode 58 generates an electric potential difference between the pixel electrode 30 and the transition electrode 58 so as to generate an electric field E between the electrodes 58 and 30. Accordingly, the transition electrode 58 is configured to form the point of origin of the initial alignment transition from the spray alignment to the bend alignment.

In addition, the transition electrode 58 is formed such that at least a part of a formation area (the outer shape of the transition electrode 58) in the transition electrode 58 is located on the outer side of a formation area (the outer shape of the pixel electrode 30) in the pixel electrode 30, in a plan view (in a case where the substrate face is viewed in a direction perpendicular to the component substrate 12).

In particular, according to this embodiment, an end part (the scanning line 36A side) of the pixel electrode 30 is located on the transition electrode 58 in a plan view. In other words, end parts of the transition electrode 58 and the pixel electrode 30 are configured to be overlapped with each other (see FIG. 3).

In the liquid crystal device according to this embodiment, as shown in FIG. 3, the transition electrode 58 is disposed in an island shape. In addition, the transition electrode 58 is disposed such that the convex part 78 is overlapped with the concave part 80 that is disposed in the pixel electrode 30. The transition electrode 58 is formed in an approximately rectangular shape and extends along the direction of the scanning line 36A. In addition, the transition electrode 58 is electrically connected to the scanning line 36A through the contact hole 57. In other words, in the liquid crystal device according to this embodiment, the transition electrode 58 is configured to have a same electric potential as that of the scanning line 36A. Accordingly, driving of the transition electrode is not needed to be controlled. As a result, the driving can be controlled in an easy manner, compared to a general configuration. The transition electrode 58 may be configured to be directly laminated on the scanning line 36A not through the contact hole. Here, the transition electrode may be considered to be directly formed on the scanning line 36A. However, in such a case, the shape of the scanning line becomes complicated, and resistance increases locally. On the other hand, by disposing the separate transition electrode 58 on the scanning line 36A as described above, the position of formation and shape of the transition electrode 58 can be adjusted in an easy manner. Accordingly, the degree of freedom of design thereof can be improved.

The end parts of the transition electrode 58 and the pixel electrode 30 are configured to be overlapped with each other. Thus, the liquid crystal molecules 48 located on the end part of the pixel electrode 30 which is overlapped with the transition electrode 58 can be aligned by the electric field E that is generated between the transition electrode 58 and the pixel electrode 30 in the initial alignment operation.

By using the above-described configuration, the transition electrode 58 can be disposed in a desired position within the pixel area. Accordingly, the place in which the transition nucleus forming the point of origin of the initial alignment transition is generated can be set to an arbitrary position.

As shown in FIGS. 4 and 5, the component substrate 12 has a substrate main body 60 that is formed of a translucent material such as glass, crystal, or plastic as its base body. On the inner side (the liquid crystal layer 16 side) of the substrate main body 60, the scanning line 36A, the capacitor line 36B, a gate insulting film 62 that insulates the scanning line 36A and the capacitor line 36B, the semiconductor layer 50 that is disposed to face the scanning line 36A through the gate insulating film 62, the source electrode 34B (the data line 34A) and the drain electrode 52 that are connected to the semiconductor layer 50, and the capacitor electrode 54 that is connected to the drain electrode 52 and is disposed to face the capacitor line 36B through the gate insulating film 62 are formed. In other words, the TFT element 32 and the storage capacitor 38 connected thereto are formed. In addition, the transition electrode 58 that is disposed to face the scanning line 36A through the gate insulating film 62 is disposed. This transition electrode 58 is formed of a transparent conductive material such as ITO, as the pixel electrode 30. Accordingly, even the liquid crystal molecules 48 located on the transition electrode 58 can contribute to display, and thereby a decrease of the aperture ratio is prevented.

By covering the TFT element 32 and the transition electrode 58 and flattening concaves and convexes on the substrate due to the TFT element 32, the transition electrode 58, and the like, the dielectric film 66 is disposed. This dielectric film 66 is a transparent insulating film that is formed of a silicon oxide film, a silicon nitride film, or the like. In addition, It is preferable that the film thickness of at least a part of the dielectric film 66 which covers the transition electrode 58 is equal to or smaller than 1 μm.

Generally, the electrodes are needed to be formed to be adjacent for a horizontal electric field type. Since the electrodes are formed by using a photolithographic technique, a gap between the electrodes is set to about 2 μm due to a technical problem such as the precision of a process. On the other hand, according to this embodiment, since the film thickness of the dielectric film 66 that is interposed between the pixel electrode 30 and the transition electrode 58 is equal to or smaller than 1 μm, a distance between the electrodes decreases, compared to that of the general horizontal electric field type. Accordingly, an equivalent electric field can be generated by a lower voltage, and thereby the initial transition can be generated by the generated electric field.

In addition, the pixel electrode 30 formed on the dielectric film 66 and the capacitor electrode 54 are electrically connected to each other through the pixel contact hole 56 that reaches the capacitor electrode 54 by passing through the dielectric film 66. In addition, an alignment film 68 is formed to cover the pixel electrode 30. This alignment film 68, for example, is formed of polyimide, and a rubbing process is performed in the direction of axis X of the sub pixel area. A horizontal alignment film that is adjacent to the liquid crystal layer 16 is formed, and is rubbed such that the direction of the liquid crystal molecules 48 becomes vertically symmetrical with respect to the center of the cell. Here, the direction of the electric field E between the transition electrode 58 and the pixel electrode 30 is set as 0°. The rubbing angle is not 0°.

The opposing plate 14 is formed of a translucent material such as glass, crystal, or plastic and has a substrate main body 70 as its base body. On the inner side (the liquid crystal layer 16 side) of the substrate main body 70, color filters 72 that are formed of color material layers of color types corresponding to each sub pixel area, a common electrode 74, and an alignment film 76 are laminated.

The common electrode 74 is formed of a transparent conductive material such as ITO and is formed in a planar beta shape covering a plurality of sub pixel areas.

The alignment film 76, for example, is formed of polyimide and is formed to cover the common electrode 74. For the surface of the alignment film 76, a rubbing process is performed in the aligning direction R of the alignment film 68.

In addition, in one corner part of the sub pixel, a spacer 82 in a columnar shape that regulates a gap between the component substrate 12 and the opposing substrate 14 is formed. The spacer 82, for example, is formed of a resin material such as polyimide and is formed in a sphere shape having a diameter that is equivalent to the gap between the component substrate 12 and the opposing substrate 14. In addition, the spacer 82 is disposed in accordance with each sub pixel area.

Next, the initial transition operation of the liquid crystal device 10 of the OCB mode will be described with reference to a drawing. Here, FIGS. 6A and 6B are diagrams showing the aligning states of the liquid crystal molecules of the OCB mode.

In the liquid crystal device of the OCB mode, in the initial state (in a non-operation time period), as shown in FIG. 6A, the liquid crystal molecules 48 are in an open aligning state in a spray shape (the spray alignment). On the other hand, in a display operation, the liquid crystal molecules 48 as shown in FIG. 4 are in an aligning state (the bend alignment) bent in the shape of a bow. The liquid crystal device 10 is configured to implement high-speed responsiveness of the display operation by modulating the transmissivity to the degree of curving of the bend alignment in the display operation.

In the liquid crystal device 10 of the OCB mode, the aligning state of the liquid crystal molecules for a case where power is off is the spray alignment shown in FIG. 6A. Thus, so-called an initial transition operation for transiting the aligning state of the liquid crystal molecules 48 from the initial spray alignment shown in FIG. 6A to the bend alignment in the display operation shown in FIG. 6B by applying a voltage of a minimum threshold value or more required for generating a reaction that is generated in a case where the power is turned on to the liquid crystal molecules 48 is needed. Here, when the initial transition is not performed sufficiently, deterioration of the display and high-speed responsiveness occurs.

In the liquid crystal device 10 according to this embodiment, the transition electrode 58 that is formed on the component substrate 12 side and has an electric potential difference from the pixel electrode 30 is provided. Accordingly, by applying a voltage between the electrodes 30 and 58, the initial transition operation for the liquid crystal layer 16 can be performed.

The liquid crystal device 10 according to this embodiment has a control unit that performs a control operation for the liquid crystal panel. The control unit is configured to include a common electrode control section that controls the electric potential of the common electrode 74 disposed on the opposing substrate 14 side and a pixel electrode control section that controls the electric potential of the pixel electrode 30 through the TFT element 32. In addition, the control unit may be configured to include a transition electrode control section that controls the electric potential of the transition electrode 58. In such a case, the electric potentials of the transition electrode 58 and the pixel electrode 30 can be controlled independently. Accordingly, delicate control of the electric potentials can be performed for both the initial transition operation and the image display operation.

By applying a DC or AC voltage to the transition electrode 58 as the initial transition operation for the liquid crystal layer 16 of the above-described liquid crystal device 10, as shown in FIG. 4, an electric field E is generated in the diagonal direction between the pixel electrode 30 and the transition electrode 58. Accordingly, the electric field E including an electric field component in the direction of the normal line of the substrate and an electric field component in the direction of the face of the substrate is applied to the liquid crystal layer 16.

Accordingly, in a boundary area between the pixel electrode 30 and the transition electrode 58, the liquid crystal molecules 48 are tilted by the electric field in the diagonal direction. As a result, a plurality of liquid crystal areas having different aligning states is formed in the liquid crystal layer 16 near the opposing substrate 14. Then, the initial transition of the liquid crystal layer 16 is generated as the boundary area of the liquid crystal area becomes a nucleus to be propagated to the vicinity thereof. In this embodiment, as shown in FIG. 3, the transition electrode 58 is formed along the direction of extension of the scanning line 36A over the island shapes, that is, a plurality of the sub pixel areas. Accordingly, by using the electric field E generated between the pixel electrode 30 and the transition electrode 58, the initial transition can be propagated from the end part of the shorter side of the pixel electrode 30 in the shape of a band. In other words, at a time around the initial transition operation, the transition of alignment can progress by the bulk of the liquid crystal, and thus, the initial transition can progress uniformly. At that moment, as shown in FIG. 3, the area in which the electric field E is generated coincides with the direction of extension of the data line 34A. Accordingly, the liquid crystal molecules 48 can be aligned in a direction different from the direction R of alignment of the liquid crystal in a case where the electric field is applied.

In addition, as described above, the film thickness of the dielectric film 66 that is interposed between the pixel electrode 30 and the transition electrode 58 is equal to or smaller than 1 μm, and the distance between the electrodes is short. Accordingly, the initial transition can be generated by using a relatively low voltage value. As a result, the initial transition can progress uniformly in a short time.

In addition, as shown in FIG. 3, the end parts of the transition electrode 58 and the pixel electrode 30 are configured to be overlapped with each other, and thus, the electric field E acts on the liquid crystal molecules 48 located on the end part of the pixel electrode 30. Accordingly, by tilting the liquid crystal located on the end part of the pixel electrode 30 in the direction of the film thickness, the liquid crystal molecules 48 can be transited in a broad range on the pixel electrode 30.

However, in an image display operation for the liquid crystal device 10, when there is an electric potential difference between the transition electrode 58 and the common electrode 74, there is a possibility that the alignment of the liquid crystal molecules 48 is disturbed near the boundary between the transition electrode 58 and the pixel electrode 30. Thus, in the liquid crystal device 10 according to this embodiment, the electric potentials of the transition electrode 58 and the common electrode 74 are set to a same voltage value in a case where the image display operation is performed, and thereby inconvenience for the image display operation is prevented.

In addition, according to this embodiment, the rubbing direction of the alignment films 68 and 76 is configured to be a direction (the direction of extension of the scanning line 36A) of the shorter side of the pixel electrode 30. However, the rubbing direction (the initial aligning direction of the liquid crystal) is not limited to the aligning direction R shown in FIG. 3.

It is preferable that the rubbing direction is selected such that the direction of the electric field E generated between the pixel electrode 30 and the transition electrode 58 intersects the rubbing direction (the initial aligning direction) in a case where a voltage is applied to the transition electrode 58 on the component substrate 12 side in the initial transition operation. Thus, as long as the above-described relationship is satisfied, the rubbing direction, for example, may be set to a direction tilted from the directions of extension of the data line 34A and the scanning line 36A.

As described above, according to the liquid crystal device 10 of this embodiment, by generating the electric field E between the pixel electrode 30 and the transition electrode 58, the transition nucleus that becomes the point of origin for the initial transition can be formed. In addition, a structure in which the transition electrode 58 and the pixel electrode 30 are vertically disposed is formed. Thus, by decreasing the film thickness (equal to or smaller than 1 μm) of the dielectric film 66 that is interposed between the electrodes 30 and 58, a distance between the electrodes 30 and 58 can be shortened, compared to a general electrode structure using the horizontal electric field. As a result, the initial transition of the liquid crystal layer 16 can be performed in a short time by using a low voltage, compared to a general case.

In addition, in the liquid crystal device 10 according to this embodiment, the bend parts 78 and 80 located in portions in which the end parts of the transition electrode 58 and the pixel electrode 30 are two-dimensionally overlapped with each other are formed in the shorter side located on a side to which the TFT element 32 of the pixel electrode 30 is connected. However, parts corresponding to each corner part of the shape of the pixel electrode 30 may be configured as the bend parts, and the shape of the transition electrode 58 that is overlapped with the end part of the pixel electrode 30 may be configured to have a linear shape along a part of the shorter side adjacent to each corner part on the shorter side located on a side to which the TFT element 32 is connected and a part of the longer side of the pixel electrode 30 adjacent to each corner part.

In such a case, each corner part of the pixel electrode 30 can be used as the bend part, and the transition electrode is formed wide along both the shorter side and the longer side of the pixel electrode 30 that is located adjacent to the corner part. Accordingly, control of transition can be performed in a stable manner.

### Second Embodiment

Next, a second embodiment of the invention will be described with reference to the accompanying drawing.

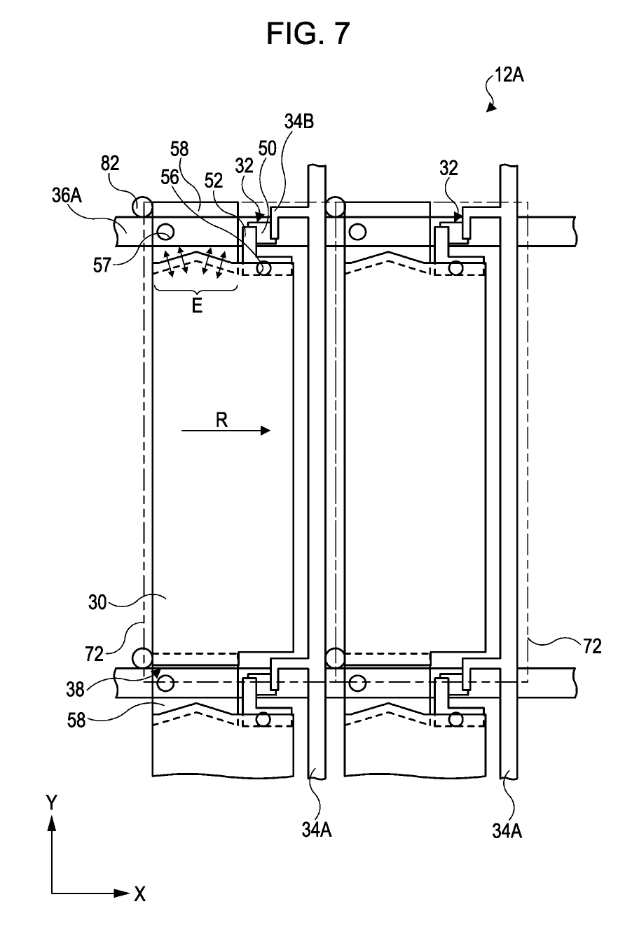

FIG. 7 is a diagram showing a schematic configuration of a liquid crystal device according to the embodiment. The liquid crystal device according to this embodiment, as the liquid crystal device according to the above-described embodiment, is a transmission-type liquid crystal device of a TFT active matrix type. The special aspects of this embodiment relate to the shapes of the pixel electrode 30 and the transition electrode 58. Accordingly, the basic configuration of the liquid crystal device according to this embodiment is the same as that according to the above-described embodiment. Thus, to each common constituent element, a same reference sign is assigned, and a detailed description thereof is omitted or abbreviated here.

The liquid crystal device according to this embodiment, as shown in FIG. 7, end parts of the transition electrode 58 and the pixel electrode 30 located adjacent thereto are configured to be overlapped with each other. In other words, a part of the transition electrode 58 is formed as a holding capacitor of an adjacent pixel. The transition electrode 58 is disposed within a planar area of the pixel electrode 30, and the storage capacitor 38 is configured to have the transition electrode 58 and the pixel electrode 30 as electrodes thereof. The scanning line 36A (the gate electrode), for example, is formed of a metal substance, an alloy, metallic silicide, or poly silicide that include at least one metal such as aluminum (Al) and copper (Cu) having low resistance, a lamination thereof, conductive poly silicon, or the like. Although the damping time constant of the scanning line 36A connected through the contact hole 57 increases by using the transition electrode 58 as the holding capacitor electrode, the damping time constant can decrease by using the metal having low resistance as the gate electrode.

In the configuration according to this embodiment, compared to a general configuration, the film thickness of the dielectric film 66 disposed between the transition electrode 58 and the pixel electrode 30 is small. Accordingly, the capacitance of the storage capacitor 38 can increase without increasing the area of the transition electrode 58 as the holding capacitor electrode. Therefore, flicker and burn-sticking can be reduced without decreasing the aperture ratio.

### Third Embodiment

Next, a third embodiment of the invention will be described with reference to the accompanying drawing.

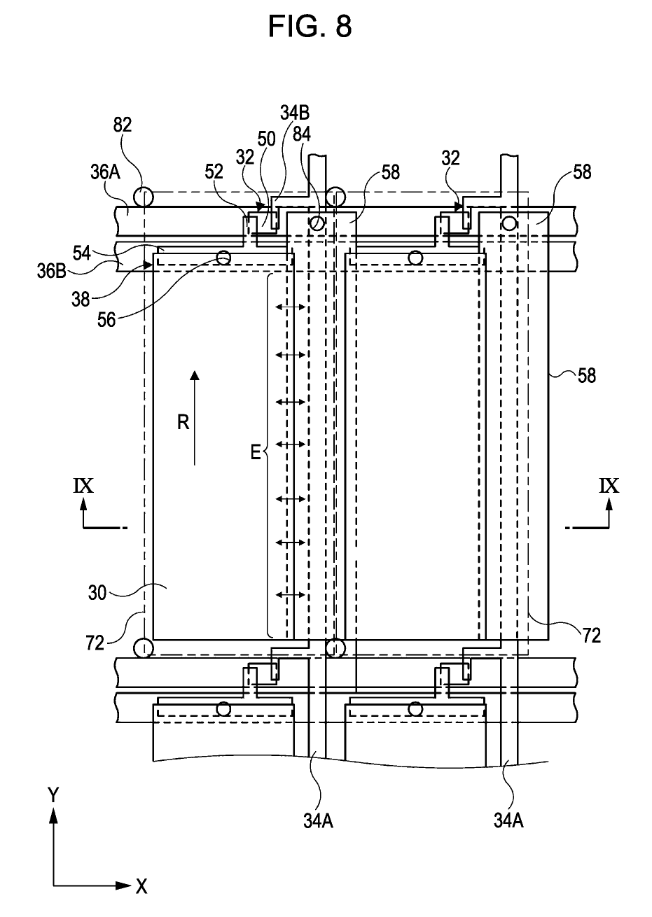

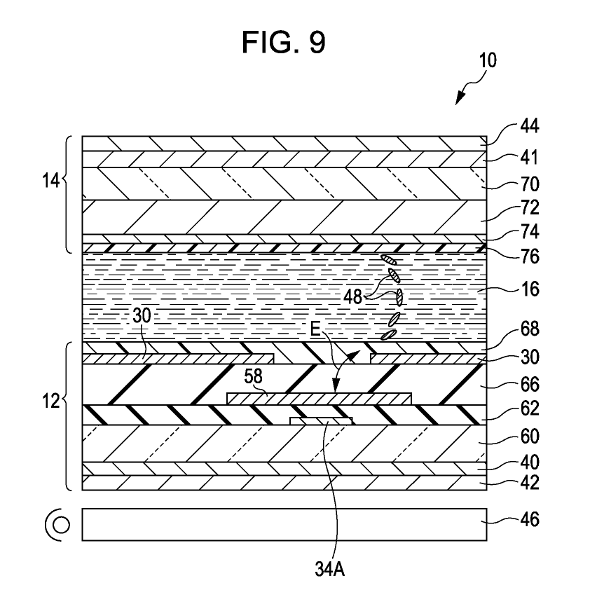

FIG. 8 is a plan view of a sub pixel area according to this embodiment. FIG. 9 is a diagram showing a sectional structure of the liquid crystal device according to this embodiment and is a cross-sectional view taken along line IX-IX shown in FIG. 8. The liquid crystal device according to this embodiment, as the liquid crystal device according to the above-described embodiment, is a transmission-type liquid crystal device of a TFT active matrix type. The special aspect of this embodiment is that the transition electrode 58 and the data line 34A are electrically connected to each other through a contact hole 84. Accordingly, the basic configuration of the liquid crystal device according to this embodiment is the same as that according to the above-described embodiment. Thus, to each common constituent element, a same reference sign is assigned, and a detailed description thereof is omitted or abbreviated here.

In the liquid crystal device according to this embodiment, as shown in FIG. 8, the transition electrode 58 having a stripe shape is disposed between the pixel electrodes 30 so as to cover the data line 34A in a plan view (in a state viewed from the direction perpendicular to the pixel electrode 30). As shown in FIG. 9, the transition electrode 58 is disposed in a layer that is positioned higher than that of the data line 34A and lower than that of the pixel electrode 30.

In addition, the transition electrode 58 is electrically connected to the data line 34A through the contact hole 84 (see FIG. 8). The transition electrode 58 generates an electric potential difference between the pixel electrode 30 and the transition electrode 58 so as to generate an electric field E between the electrodes 58 and 30. Accordingly, the transition electrode 58 is configured to form the point of origin of the initial alignment transition from the spray alignment to the bend alignment.

Hereinafter, the initial transition operation in the liquid crystal device according to this embodiment will be described with reference to the accompanying drawing.

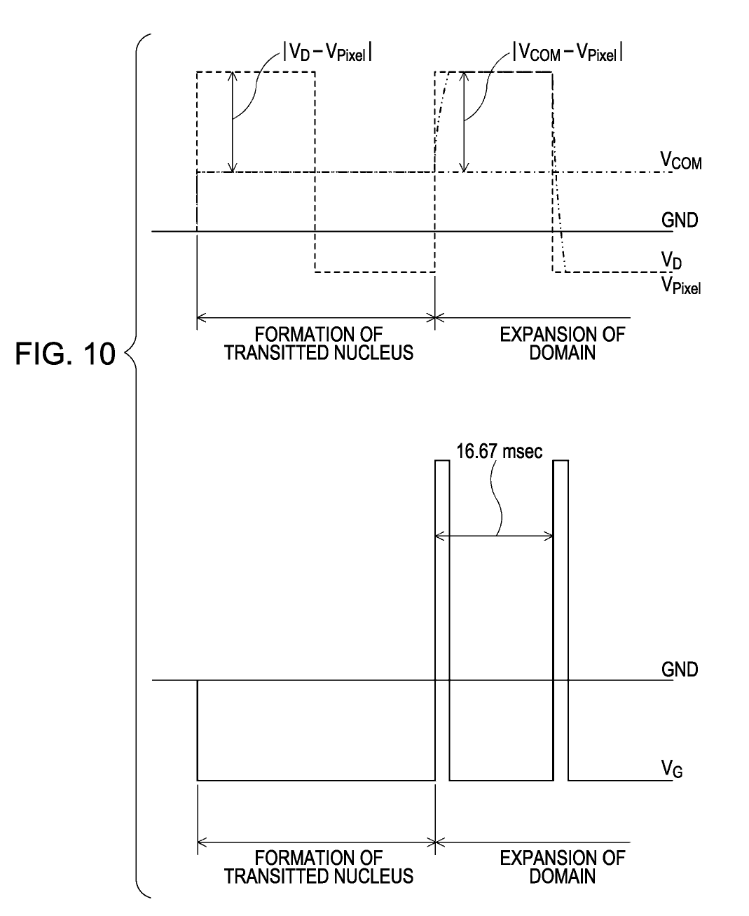

FIG. 10 is a timing chart for the initial transition operation of the liquid crystal device according to this embodiment. As shown in FIG. 10, a transition nucleus is formed by an electric potential difference |V_{D}−V_{Pixel}| between the electric potential V_{D} of the data line 34A (see FIG. 9) and the electric potential V_{Pixel} of the pixel electrode 30 (see FIG. 9). In addition, the band domain is expanded by an electric potential difference |V_{com}−V_{Pixel}| between the electric potential V_{Pixel} of the pixel electrode 30 and the electric potential V_{com} of the common electrode 74 (see FIG. 9). The electric potential V_{G} of the gate signal is in the OFF state in the transition nucleus forming process so as to prevent |V_{D}−V_{Pixel}|=0.

### Electronic Apparatus

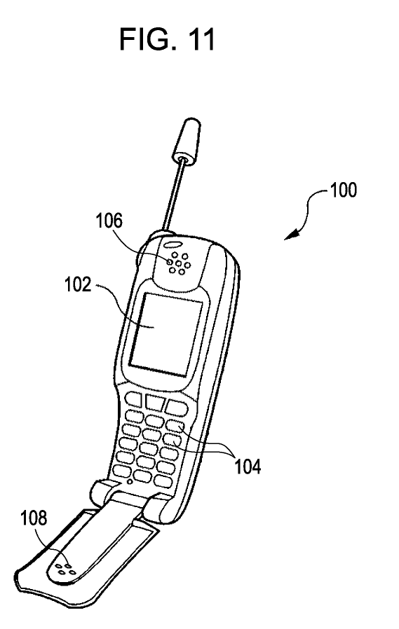

FIG. 11 is a perspective view showing an example of an electronic apparatus according to this embodiment. As shown in FIG. 11, the cellular phone (the electronic apparatus) 100 is configured to include the liquid crystal device according to the above-described embodiment as a small-size display unit 102, a plurality of operation buttons 104, an ear piece 106, and a mouth piece 108. Since the liquid crystal device according to the above-described embodiment can smoothly perform the initial transition operation of the OCB mode in a short time by using a low voltage, the cellular phone 100 having the liquid crystal display unit having superior display quality can be provided.

The liquid crystal device according to each of the above-described embodiments can be appropriately used as an image display unit of an electronic book, a personal computer, a digital still camera, a liquid crystal TV set, a video cassette recorder of a view-finder type or a monitor direct-view type, a pager, an electronic organizer, a calculator, a word processor, a workstation, a video phone, a POS terminal, an apparatus having a touch panel, or the like, in addition to the above-described electronic apparatus. Furthermore, in any electronic apparatus such as a high-speed LCD designed for moving pictures for a cellular phone LCD or a vehicle-mounted LCD, a 3D liquid crystal display or a two-screen liquid crystal display that use a field sequential (FS) display method, a light valve for video enlarging devices, and the like, a superior display quality having high brightness and high contrast can be acquired.

The entire disclosure of Japanese Patent application No. 2007-305358, field Nov. 27, 2007 is expressly incorporated by reference herein.

What is claimed is:

1. A liquid crystal device that performs a display operation by transiting the aligning state of the liquid crystal layer from spray alignment to bend alignment, the liquid crystal device comprising:
a first substrate and a second substrate disposed to face each other;
a liquid crystal layer sandwiched between the first substrate and the second substrate;
a scanning line and a data line that intersect with each other;
a plurality of pixel electrodes;
an insulating film that is disposed between the liquid crystal layer and at least one of the scanning line and the data line;
a transition electrode that is electrically connected to the scanning line or the data line through a contact hole formed in the insulating film; and
a dielectric film that is disposed between the transition electrode and the pixel electrode.

2. The liquid crystal device according to claim 1, wherein at least a part of the transition electrode is overlapped with an end part of the pixel electrode in a plan view.

3. The liquid crystal device according to claim 2, wherein a bend part is formed in the pixel electrode or the transition electrode.

4. The liquid crystal device according to claim 1, wherein the transition electrode is electrically connected to the scanning line through the contact hole and is disposed in a same layer as that of the data line.

5. The liquid crystal device according to claim 4, wherein the transition electrode is overlapped with an end part of the pixel electrode that is driven by the scanning line that is disposed to be adjacent to the scanning line to which the transition electrode is electrically connected.

6. The liquid crystal device according to claim 1, wherein the transition electrode is electrically connected to the data line through the contact hole.

7. An electronic apparatus comprising the liquid crystal device according to claim 1.
